(19) United States
(12) Patent Application Publication
(10) Pub. No.: US 2024/0031262 A1
(43) Pub. Date: Jan. 25, 2024

(54) USAGE AND POLICY DRIVEN METRIC COLLECTION

(71) Applicant: VMWARE, INC., Palo Alto, CA (US)

(72) Inventors: SAMEER CHANDRA TATIRAJU, Bangalore (IN); AGNELLO LLOYED NORONHA, Bangalore (IN); MANISH BALCHAND JAIN, Bangalore (IN)

(21) Appl. No.: 17/967,921

(22) Filed: Oct. 18, 2022

(30) Foreign Application Priority Data
Jul. 22, 2022 (IN) 202241042170

(51) Int. Cl. H04L 43/067; H04L 43/028

(52) U.S. Cl. CPC H04L 43/067; H04L 43/028

(57) ABSTRACT

A plurality of values of a metric can be collected by a cloud monitoring system over a period of time from a metric source. One of a plurality of usage frequency categories associated with the metric over the period of time can be determined. One of a plurality of change frequency categories associated with the metric over the period of time can be determined. A collection frequency associated with the metric can be modified based on the determined usage frequency category and the determined change frequency category. A subsequent query for the metric can be responded to based on the determined usage frequency category and the determined change frequency category.

### RELATED APPLICATIONS

Benefit is claimed under 35 U.S.C. 119(a)-(d) to Foreign Application Serial No. 202241042170 filed in India entitled “USAGE AND POLICY DRIVEN METRIC COLLECTION”, on Jul. 22, 2022, by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for usage and policy driven metric collection according to one or more embodiments of the present disclosure.

FIG. 2 is a diagram of a system for usage and policy driven metric collection according to one or more embodiments of the present disclosure.

FIG. 3 is a diagram of a system usage and policy driven metric collection according to one or more embodiments of the present disclosure.

FIG. 4 is a diagram of a machine for usage and policy driven metric collection according to one or more embodiments of the present disclosure.

### DETAILED DESCRIPTION

The term “virtual computing instance” (VCI) covers a range of computing functionality, such as virtual machines, virtual workloads, data compute nodes, clusters, and containers, among others. A virtual machine refers generally to an isolated user space instance, which can be executed within a virtualized environment. Other technologies aside from hardware virtualization can provide isolated user space instances, also referred to as data compute nodes, such as containers that run on top of a host operating system without a hypervisor or separate operating system and/or hypervisor kernel network interface modules, among others. Hypervisor kernel network interface modules are data compute nodes that include a network stack with a hypervisor kernel network interface and receive/transmit threads. The term “VCI” covers these examples and combinations of different types of data compute nodes, among others.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs. While the present disclosure refers to VCIs, the examples given could be any type of virtual object, including data compute node, including physical hosts, VCIs, non-VCI containers, virtual disks, and hypervisor kernel network interface modules. Embodiments of the present disclosure can include combinations of different types of data compute nodes.

VCIs can be created in a public cloud environment. The term public cloud refers to computing services (hereinafter referred to simply as “services”) provided publicly over the Internet by a cloud service provider. A public cloud frond end refers to the user-facing part of the cloud computing architecture, such as software, user interface, and client-side devices. A public cloud backend refers to components of the cloud computing system, such as hardware, storage, management, etc., that allow the front end to function as desired. Some public cloud backends allow customers to rent VCIs on which to run their applications. Users can boot a VCI base image to configure VCIs therefrom. Users can create, launch, and terminate such VCIs as needed. Users can be charged, for example, for the time during which the VCI is in operation.

Monitoring is an integral part of infrastructure, software, and hardware in order to offer users reliable and long-term services. With technologies like public cloud solutions and virtualization, monitoring and observability needs have become more and more useful for meeting user demands and resolving issues within a Service Level Agreement (SLA). Many applications built for monitoring (referred to herein as “cloud monitoring systems”) provide solutions, such as root cause analysis, performance reporting, business insights, and planning. A cloud monitoring system can deliver operations management with application-to-storage visibility across physical, virtual, and cloud infrastructures. One example of a cloud monitoring system is vRealize Operations (vROps), though embodiments of the present disclosure are not so limited.

Software systems, even small ones, can produce a large number of metrics. Metrics, as known to those of skill in the art, refer to the numeric estimation of system status and performance (exposed either by the system or developer), which can be periodically collected by a cloud monitoring system. Metrics are sometimes referred to herein simply as “data.” Even the simplest of systems, like a minimal click-and-buy online store, includes various components like a front-end server, a back-end server, and a database server—each of which can expose a bulk of metrics. The number of metrics increases as these software systems grow in magnitude and complexity. To collect, process, and store data, layers such as data collection, data processing, and data persistence can be utilized. However, in many cases, data that is no longer in use may also be collected, processed, and stored. This results in ROT (Redundant, Outdated, Trivial) data being managed. This ROT data costs enterprises in managing and cleaning by means of software and/or manual audits. Availing enterprise software for such tasks results in capital expenditures, and storing and/or maintaining such ROT data on public clouds results in unwanted operational expenses. Moreover, assigning a human resource to carry out such tasks can result in wasted man hours and/or erroneous deletion of useful metrics.

Previous approaches have attempted to minimize the collection of metrics or collect only a subset of metrics. However, these approaches can be expensive and complex as they may involve one or more convoluted statistical algorithms. Additionally, if a client queries a metric that is being discarded as being a dependent metric, then there is undesirable computation time involved in calculating and returning the value. For example, assume there are two metrics, “used memory” and “unused memory,” where unused memory is being discarded as a dependent metric. If the client queries for unused memory, then the sequence of events can include: (1) the metric is registered as a miss from the metric monitoring platform, (2) the system checks the database/lookup table to see the equation between dependent metrics, (3) the system fetches the used memory from the metrics cloud monitoring system, (4) the system calculates overall memory minus used memory, and (5) the system returns the value to the client. Such an approach can involve significant time in calculations.

Embodiments of the present disclosure can greatly simplify this approach. Instead of relying on correlation-based statistical models, embodiments herein include an architecture that can determine when to continue, pause, delay, and/or stop the collection of metrics. In addition, embodiments herein include a “smart response” mechanism that can define the immediate response in cases where a less-frequently collected metric is queried. In some embodiments, for example, the last collected value can be retrieved from a metadata store instead of the “current value” being queried via an Application Programming Interface and fetched from the cloud monitoring system, resulting in significant time savings. To do so, embodiments of the present disclosure can determine how frequently a metric is queried by a client, and how frequently the value of that metric changes.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

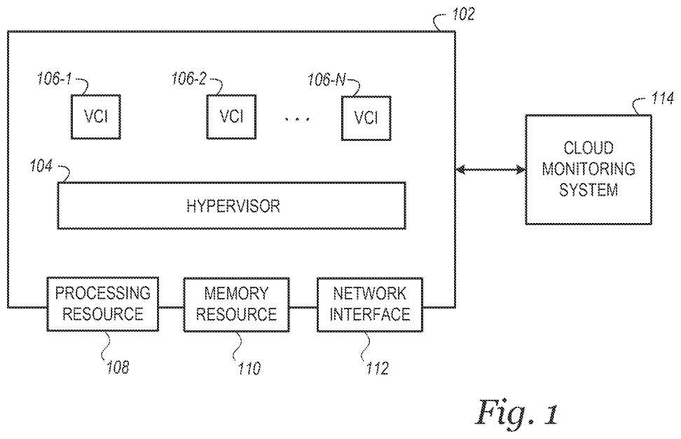

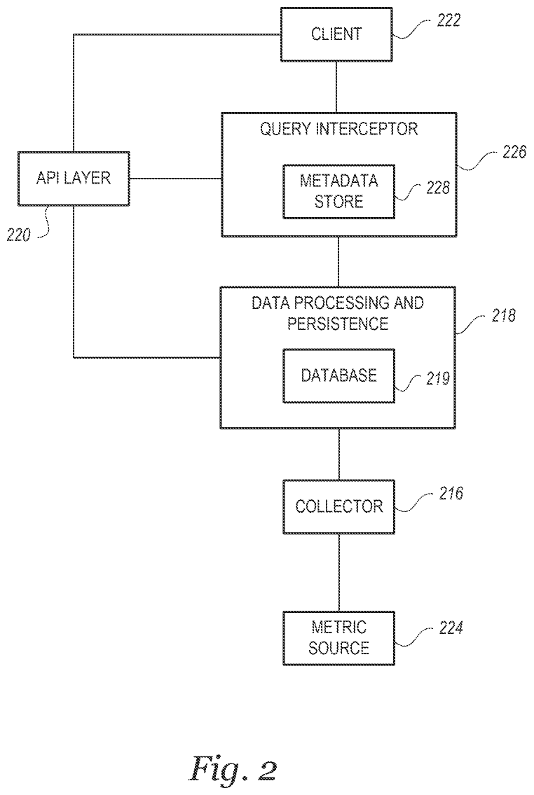

The figures herein follow a numbering convention in which the first digit or digits correspond to the drawing figure number and the remaining digits identify an element or component in the drawing. Similar elements or components between different figures may be identified by the use of similar digits. For example, 228 may reference element “28” in FIG. 2, and a similar element may be referenced as 928 in FIG. 9. Analogous elements within a Figure may be referenced with a hyphen and extra numeral or letter. Such analogous elements may be generally referenced without the hyphen and extra numeral or letter. For example, elements 116-1, 116-2, and 116-N in FIG. 1A may be collectively referenced as 116. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for usage and policy driven metric collection according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a cloud monitoring system 114. An example of the cloud monitoring system 114 is illustrated and described in more detail below. In some embodiments, the cloud monitoring system 114 can be a server, such as a web server.

FIG. 2 is a diagram of a system for usage and policy driven metric collection according to one or more embodiments of the present disclosure. A traditional microservice driven monitoring/collection system can be roughly divided into three tiers. As shown in FIG. 2, such systems include a data collector 216, a data processing and persistence layer 218, and an API layer 220. It is noted that while single entities (e.g., a single collector 216) are shown in FIG. 2, embodiments of the present disclosure are not so limited and such depiction is made for purposes of clarity. Such a system may include various numbers of the example single entities illustrated in FIG. 2. The collector 216 can be on-premises (e.g., local to a user) or cloud-based services that employ APIs to collect data from a metric source 224. The metric source 224 can be any metric source known to those of skill in the art including, for example, an application and/or infrastructure, and may or may not be cloud-based. The data processing and persistence layer 218 can ingest, process, and store the metrics in a database 219, for example, in a suitable format. The API layer can serve as an interface to the world outside the cloud, allowing the client 222 to access the data acquired. It is noted that the client 222 can be various clients including, for example, a microservice API and/or a user.

A problem with limiting such systems to these entities is that there may be no mechanism to control the frequency of collection based on a change in the value of the data collected by the collector 216 or a change in the usage of the data queried by the client 222. Stated differently, the system continues to collect data from the metric source 224 even though it may no longer be consumed by the client 222 and/or even though its value does not change for a continued period of time. Embodiments of the present disclosure include a query interceptor (QI) 226. The QI 226 can intercept incoming API requests and forward data retrieval requests to the API layer 220. The QI 226 can serve incoming API requests, store the metadata on the usage in a metadata store 228, and change the pattern of data collected. In some embodiments, the QI 226, the API layer 220, the data processing and persistence layer 218, and the collector 216 can be included in a cloud monitoring system, such as the cloud monitoring system 114, previously discussed in connection with FIG. 1.

In some embodiments, the QI 226 can forward a request from the client 222 to the API layer 220 simultaneously storing the associated information in the metadata store 228 and retrieving that information in the case of an “inactive” metric. The policy can be a set of rules that are applied in regular intervals. The goal of the policy is to decide and drive key indices using heuristic measures discussed further herein. The QI 226 can communicate with the collector 216 to start/stop the collection of data points and/or to modify the data collection frequency. The collector 216 can expose a management API, configurable using a specification, and collect accordingly.

The QI 226 can include a policy manager that can determine the actions to be taken given various factors. One factor refers to the frequency that the value of a given metric changes. In some embodiments, the frequency that the value of a metric changes can be sorted into one of a plurality of categories (referred to herein as “change frequency categories”). A first change frequency category can refer to data that does not change frequently (referred to herein as “no change”). A second change frequency category can refer to data that changes frequently (referred to herein as “frequent change”). Another factor refers to the frequency at which a particular metric is queried (e.g., by client 222). In some embodiments, the frequency at which a particular metric is queried can be sorted into one of a plurality of categories (referred to herein as “usage frequency categories”). A first usage frequency category can refer to a metric that is queried frequently (referred to herein as “frequent usage”). A second usage frequency category can refer to a metric that is queried intermittently (referred to herein as “intermittent usage”). A third usage frequency category can refer to a metric that is queried infrequently (referred to herein as “no usage”).

In order to control the actions to be taken by the system based on these factors, the system can include predefined policies which can be utilized by the QI 226. These policies are show in part in Table 1.

TABLE 1

| Change in | | |
|---|---|---|
| Value | Usage Frequency | Action Taken |
| No change | Frequent | Decrease collection |
| | | frequency |
| No change | Intermittent | Decrease collection |
| | | frequency |
| No change | No usage | Stop collection |
| Frequent | Frequent | Continue collection |
| Frequent | Intermittent | Decrease collection |
| | | frequency |
| Frequent | No usage | Decrease collection |
| | | frequency |

With reference to Table 1, the collection frequency can be decreased responsive to a plurality of scenarios. In some embodiments the collection frequency is reduced responsive to the determined usage frequency category being the first usage frequency category, and the determined change frequency category being the first change frequency category. In some embodiments the collection frequency is reduced responsive to the determined usage frequency category being the second usage frequency category, and the determined change frequency category being the first change frequency category. In some embodiments the collection frequency is reduced responsive to the determined usage frequency category being the second usage frequency category, and the determined change frequency category being the second change frequency category. In some embodiments the collection frequency is reduced responsive to the determined usage frequency category being the third usage frequency category, and the determined change frequency category being the second change frequency category.

With reference to Table 1, the collection frequency can be maintained or continued responsive to the determined usage frequency category being the first usage frequency category, and the determined change frequency category being the second change frequency category. With reference to Table 1, collection can be stopped responsive to the determined usage frequency category being the third usage frequency category, and the determined change frequency category being the first change frequency category.

The determination to categorize the usage frequency as intermittent or no usage and to categorize the change in value as constant or variable is based on various parameters. The usage frequency and change in value can be determined by the policy manager every n*s seconds, where n is the number of cycles and s is the minimum system default collection interval time. Determining whether usage is frequent, intermittent, or infrequent (no usage) can depend on the client querying frequency for a metric m by the following formula:

$$u = \frac{q}{n} * 100$$

where
q is the metric m queried by the client 222 in c*n seconds,
c is the minimum collection time for the given metric m.

That is, every c seconds, m will be collected once (one cycle), n is the number of cycles (a user-defined variable used for baselining). The result of the formula above can be categorized into three categories (of percentages):

$$u = \{ \begin{matrix}> 5 to \leq 100 , & High / Frequent usage \\ > 0 to \leq 5 , & Intermittent usage \\ 0 & No usage\end{matrix}$$

It is noted that 0% is not unachievable since usage frequency for n cycles is considered. For instance, if n is 100 cycles or 3000 seconds (given the minimum collection time, c, is 30 seconds), then it is implicit that there is no query from the client 222 for metric m in the last 100 cycles. When the metric is classified as intermittent usage, the minimum collection time (c) may be adjusted for that metric, which can be given by:

$${c}^{′} = \frac{n}{q} * c$$

where c′ is the new collection time for metric m.

The policy manager may not change the collection time c of a metric m in every run, but the change may be conditional on the value of Δu. c may be changed only if Δu is a non-zero value and the usage frequency class changes, for example, from “intermittent” to “frequent,” “intermittent” to “no usage,” or vise versa. The change in value can be defined as a constant if for n cycles the slope of the line is unchanged. Otherwise, the change can be categorized as “frequent.”

As previously discussed, some embodiments include responding to a subsequent query for a metric based on the determined usage frequency category and the determined change frequency category. Table 2 illustrates that in a case of a high-frequency frequently-used metric, the query is sent to the API layer which fetches the current value from the cloud monitoring service and returns it. In other cases, the QI 226 has a value available in the metadata store 228 that it can reply with instantly, greatly reducing processing time.

| Change in | | |
|---|---|---|
| Value | Usage Frequency | Response |
| No change | Frequent | Last collected value |
| No change | Intermittent | Last collected value |
| No change | No usage | Last collected value |
| Frequent | Frequent | Fetch current value |
| Frequent | Intermittent | Last collected value |
| Frequent | No usage | Determine average of last n |
| | | samples |

Stated differently, in some embodiments, a last collected value of the metric can be retrieved from the metadata store 228 responsive to the determined usage frequency category being the first usage frequency category, and the determined change frequency category being the first change frequency category. In some embodiments, a last collected value of the metric can be retrieved from the metadata store 228 responsive to the determined usage frequency category being the second usage frequency category and the determined change frequency category being the first change frequency category. In some embodiments, a last collected value of the metric can be retrieved from the metadata store 228 responsive to the determined usage frequency category being the third usage frequency category and the determined change frequency category being the first change frequency category. In some embodiments, a last collected value of the metric can be retrieved from the metadata store 228 responsive to the determined usage frequency category being the second usage frequency category and the determined change frequency category being the second change frequency category.

In some embodiments, such as those with frequently changing value and no usage (e.g., the bottom row), the collection of that metric may have been stopped but because it is frequently changing the value may have changed significantly since the last n cycles when it was recorded. Hence, the requested metric can be moved to a frequent usage category and consequently moved to intermittent as the algorithm dictates based on the client usage. Embodiments herein can provide an average value of the metric responsive to the determined usage frequency category being the first usage frequency category, and the determined change frequency category being the second change frequency category. In some embodiments, the average can include the current value. In some embodiments, the average does not include the current value.

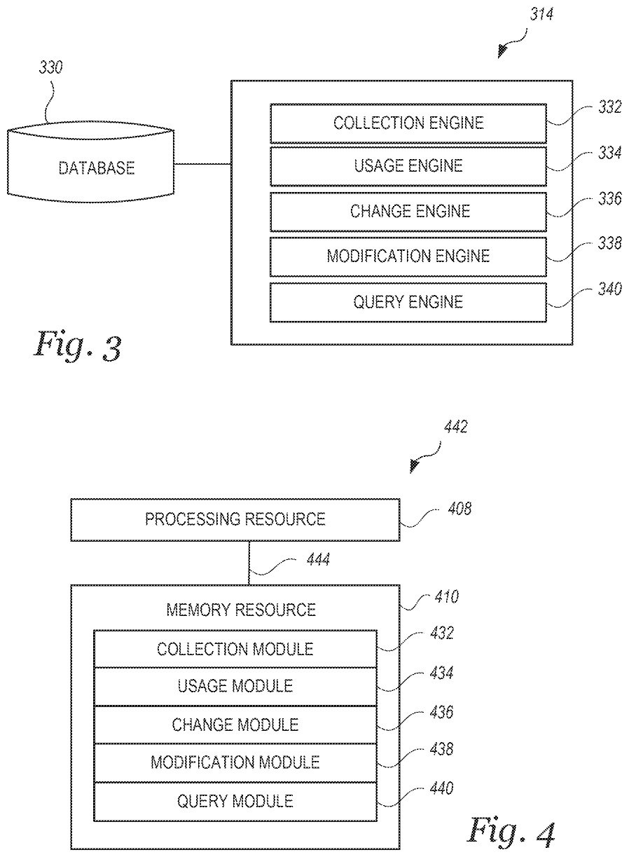

FIG. 3 is a diagram of a system 314 usage and policy driven metric collection according to one or more embodiments of the present disclosure. The system 314 can include a database 330 and/or a number of engines, for example collection engine 332, usage engine 334, change engine 336, modification engine 338, and/or query engine 340, and can be in communication with the database 330 via a communication link. The system 314 can include additional or fewer engines than illustrated to perform the various functions described herein. The system can represent program instructions and/or hardware of a machine (e.g., machine 442 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the collection engine 332 can include a combination of hardware and program instructions that is configured to collect, by a cloud monitoring system over a period of time, a plurality of values of a metric from a metric source. In some embodiments, the usage engine 334 can include a combination of hardware and program instructions that is configured to determine one of a plurality of usage frequency categories associated with the metric over the period of time. In some embodiments, the change engine 336 can include a combination of hardware and program instructions that is configured to determine one of a plurality of change frequency categories associated with the metric over the period of time. In some embodiments, the modification engine 338 can include a combination of hardware and program instructions that is configured to modify a collection frequency associated with the metric based on the determined usage frequency category and the determined change frequency category. In some embodiments, the query engine 340 can include a combination of hardware and program instructions that is configured to respond to a subsequent query for the metric based on the determined usage frequency category and the determined change frequency category.

FIG. 4 is a diagram of a machine for usage and policy driven metric collection according to one or more embodiments of the present disclosure. The machine 442 can utilize software, hardware, firmware, and/or logic to perform a number of functions. The machine 442 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 442 (e.g., the machine 442 can include internal memory resources and have access to external memory resources). In some embodiments, the machine 442 can be a virtual computing instance (VCI). The program instructions (e.g., machine-readable instructions (MRI)) can include instructions stored on the MRM to implement a particular function (e.g., an action such as configuring a certificate, as described herein). The set of MRI can be executable by one or more of the processing resources 408. The memory resources 410 can be coupled to the machine 442 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 408 can be coupled to the memory resources 410 via a communication path 444. The communication path 444 can be local or remote to the machine 442. Examples of a local communication path 444 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 444 can be such that the memory resources 410 are remote from the processing resources 408, such as in a network connection between the memory resources 410 and the processing resources 408. That is, the communication path 444 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 432, 434, 436, 438, 440 that when executed by the processing resources 408 can perform a number of functions. As used herein a module includes a set of instructions included to perform a particular task or action. The number of modules 432, 434, 436, 438, 440 can be sub-modules of other modules. For example, the secondary certificate module 434 can be a sub-module of the primary certificate module 432 and/or can be contained within a single module. Furthermore, the number of modules 432, 434, 436, 438, 440 can comprise individual modules separate and distinct from one another. Examples are not limited to the specific modules 432, 434, 436, 438, 440 illustrated in FIG. 4.

Each of the number of modules 432, 434, 436, 438, 440 can include program instructions and/or a combination of hardware and program instructions that, when executed by a processing resource 408, can function as a corresponding engine as described with respect to FIG. 3. For example, the query module 440 can include program instructions and/or a combination of hardware and program instructions that, when executed by a processing resource 408, can function as the query 340, though embodiments of the present disclosure are not so limited.

The machine 442 can include a collection module 432, which can include instructions to collect, by a cloud monitoring system over a period of time, a plurality of values of a metric from a metric source. The machine 442 can include a usage module 434, which can include instructions to determine one of a plurality of usage frequency categories associated with the metric over the period of time. The machine 442 can include a change module 436, which can include instructions to determine one of a plurality of change frequency categories associated with the metric over the period of time. The machine 442 can include a modification module 438, which can include instructions to modify a collection frequency associated with the metric based on the determined usage frequency category and the determined change frequency category. The machine 442 can include a query module 440, which can include instructions to respond to a subsequent query for the metric based on the determined usage frequency category and the determined change frequency category.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A non-transitory machine-readable medium having instructions stored thereon which, when executed by a processor, cause the processor to:
collect, by a cloud monitoring system over a period of time, a plurality of values of a metric from a metric source;
determine one of a plurality of usage frequency categories associated with the metric over the period of time;
determine one of a plurality of change frequency categories associated with the metric over the period of time;
modify a collection frequency associated with the metric based on the determined usage frequency category and the determined change frequency category; and
respond to a subsequent query for the metric based on the determined usage frequency category and the determined change frequency category, including instructions to retrieve a last collected value of the metric from a metadata store instead of querying an application programming interface (API) for a current value of the metric unless the determined change frequency category is a most frequent change category and the determined usage frequency category is a most frequent usage category.

2. The medium of claim 1, wherein the plurality of usage frequency categories include a first usage frequency category, a second usage frequency category, and a third usage frequency category.

3. The medium of claim 1, wherein the first usage frequency category corresponds to frequent usage, wherein the second usage frequency category corresponds to intermittent usage, and wherein the third usage frequency category corresponds to no usage.

4. The medium of claim 1, wherein the plurality of change frequency categories include a first change frequency category and a second change frequency category.

5. The medium of claim 4, wherein the first change frequency category corresponds to no change, and wherein the second change frequency category corresponds to frequent change.

6. The medium of claim 1, wherein:
the plurality of usage frequency categories include a first usage frequency category, a second usage frequency category, and a third usage frequency category; and
the plurality of change frequency categories include a first change frequency category and a second change frequency category.

7. The medium of claim 6, wherein the instructions to modify the collection frequency associated with the metric based on the determined usage frequency category and the determined change frequency category include instructions to decrease the collection frequency responsive to:
the determined usage frequency category being the first usage frequency category, and the determined change frequency category being the first change frequency category;
the determined usage frequency category being the second usage frequency category, and the determined change frequency category being the first change frequency category;
the determined usage frequency category being the second usage frequency category, and the determined change frequency category being the second change frequency category; or
the determined usage frequency category being the third usage frequency category, and the determined change frequency category being the second change frequency category.

8. The medium of claim 6, including instructions to maintain the collection frequency responsive to the determined usage frequency category being the first usage frequency category, and the determined change frequency category being the second change frequency category.

9. The medium of claim 6, including instructions to stop collecting values of the metric responsive to the determined usage frequency category being the third usage frequency category, and the determined change frequency category being the first change frequency category.

10. The medium of claim 6, wherein the instructions to respond to a subsequent query for the metric based on the determined usage frequency category and the determined change frequency category include instructions to retrieve a last collected value of the metric from a metadata store responsive to:
the determined usage frequency category being the first usage frequency category, and the determined change frequency category being the first change frequency category;
the determined usage frequency category being the second usage frequency category and the determined change frequency category being the first change frequency category;
the determined usage frequency category being the third usage frequency category and the determined change frequency category being the first change frequency category; or
the determined usage frequency category being the second usage frequency category and the determined change frequency category being the second change frequency category.

11. The medium of claim 6, wherein the instructions to respond to a subsequent query for the metric based on the determined usage frequency category and the determined change frequency category include instructions to query an application programming interface (API) for a current value of the metric responsive to the determined usage frequency category being the first usage frequency category, and the determined change frequency category being the second change frequency category.

12. The medium of claim 6, wherein the instructions to respond to a subsequent query for the metric based on the determined usage frequency category and the determined change frequency category include instructions to provide an average value of the metric responsive to the determined usage frequency category being the first usage frequency category, and the determined change frequency category being the second change frequency category.

13. A method, comprising:
collecting, by a cloud monitoring system over a period of time, a plurality of values of a metric from a metric source;
determining one of a plurality of usage frequency categories associated with the metric over the period of time;
determining one of a plurality of change frequency categories associated with the metric over the period of time;
modifying a collection frequency associated with the metric based on the determined usage frequency category and the determined change frequency category; and
responding to a subsequent query for the metric based on the determined usage frequency category and the determined change frequency category, including retrieving a last collected value of the metric from a metadata store instead of querying an application programming interface (API) for a current value of the metric unless the determined change frequency category is a most frequent change category and the determined usage frequency category is a most frequent usage category.

14. The method of claim 13, wherein determining the one of the plurality of usage frequency categories associated with the metric over the period of time includes intercepting incoming application programming interface (API) requests for the metric.

15. (canceled)

16. A system, comprising:
a collection engine configured to collect, by a cloud monitoring system over a period of time, a plurality of values of a metric from a metric source;
a usage engine configured to determine one of a plurality of usage frequency categories associated with the metric over the period of time;
a change engine configured to determine one of a plurality of change frequency categories associated with the metric over the period of time;
a modification engine configured to modify a collection frequency associated with the metric based on the determined usage frequency category and the determined change frequency category; and
a query engine configured to respond to a subsequent query for the metric based on the determined usage frequency category and the determined change frequency category, wherein the query engine is configured to retrieve a last collected value of the metric from a metadata store instead of querying an application programming interface (API) for a current value of the metric unless the determined change frequency category is a most frequent change category and the determined usage frequency category is a most frequent usage category.

17. The system of claim 16, wherein the plurality of usage frequency categories include a frequent usage frequency category, an intermittent usage frequency category, and a no usage frequency category; and
the plurality of change frequency categories include a no change frequency category and a frequent change frequency category.

18. The system of claim 17, wherein the modification engine is configured to decrease the collection frequency responsive to:
the determined usage frequency category being the frequent usage frequency category, and the determined change frequency category being the no change frequency category;
the determined usage frequency category being the intermittent usage frequency category, and the determined change frequency category being the no change frequency category;
the determined usage frequency category being the intermittent usage frequency category, and the determined change frequency category being the frequent change frequency category; or
the determined usage frequency category being the no usage frequency category, and the determined change frequency category being the frequent change frequency category.

19. The system of claim 17, wherein the modification engine is configured to maintain the collection frequency responsive to the determined usage frequency category being the frequent usage frequency category, and the determined change frequency category being the frequent change frequency category.

20. The system of claim 17, wherein the modification engine is configured to stop collecting values of the metric responsive to the determined usage frequency category being the no usage frequency category, and the determined change frequency category being the no change frequency category.
